(19) United States
(12) Patent Application Publication
(10) Pub. No.: US 2010/0115123 A1
(43) Pub. Date: May 6, 2010

(54) APPARATUS AND METHODS FOR BROADCASTING

(75) Inventor: Teemu AIRAMO, Poplar (GB)

Correspondence Address: MCDERMOTT WILL & EMERY LLP, 18191 VON KARMAN AVE., SUITE 500, IRVINE, CA, 92612-7108, US

(73) Assignee: MMI BROADCASTING LTD., London (GB)

(21) Appl. No.: 12/577,113

(22) Filed: Oct. 9, 2009

Related U.S. Application Data
(60) Provisional application No. 61/104,232, filed on Oct. 9, 2008.

(51) Int. Cl. G06F 15/16

(52) U.S. Cl. 709/234; 709/232

(57) ABSTRACT

A computer system for media content broadcasting comprising: a content generator operable to construct content for output by dividing the content into a plurality of content segments; a template generator for generating a template comprising an order of play of the plurality of content segments; and a communication interface operable to transmit the template to one or more user devices, and upon receipt of a request for at least one of the plurality of content segments indicated in the template, transmitting the requested content segments to a content buffer of the one or more user devices.

### TECHNICAL FIELD

The present application relates generally to broadcasting content to devices, in particular mobile devices. More specifically, the apparatus and methods disclosed relate to systems and methods for transmitting on-demand and live content to mobile devices utilising a memory buffer on the mobile device.

### BACKGROUND

In recent years, content providers have attempted to use numerous means in order to deliver various types of media to end users. One example is Internet radio, in which a continuous “stream” of audio is transmitted over the Internet to a user at a remote location. In much the same way as traditional radio broadcasts, the audience has no control over how content is delivered with internet radio. In this regard, Internet radio differs from on-demand services such as MP3 download services, podcasting and such like.

With demand for content delivered directly and reliably to mobile devices ever on the increase, content providers have attempted to introduce audiences to audio and video streaming services. However, current implementations are limited by both commercial and technical problems. In comparison to the Internet, for example, transmission of content in mobile environments poses challenges for service providers of streaming media.

Previously known methods of streaming content to mobile devices generally give poor listening experience. A lack of adequate service has arisen due to variations in delay and variations in bandwidth based on network coverage and/or incompatible hardware. Content (whether video, audio or otherwise) streaming applications require continual playback that is unaffected by the unpredictability of wireless network connections. Additionally, a network connection is not always available, for instance on flights, trains or other places where reception is poor or non-existent.

No previously known technology has successfully avoided problems associated with content streaming. Furthermore, no previously known technology enables reliable direct broadcasting to existing mobile devices over existing mobile data networks. No previously known technology enables broadcast CD-quality audio to radio listeners through their mobile device.

### SUMMARY OF THE INVENTION

According to an aspect of the invention, there is provided a computer system for media content broadcasting comprising: a content generator operable to construct content for output by dividing the content into a plurality of content segments; a template generator for generating a template comprising an order of play of the plurality of content segments; and a communication interface operable to transmit the template to one or more user devices, and upon receipt of a request for at least one of the plurality of content segments indicated in the template, transmitting the requested content segments to a content buffer of the one or more user devices.

Preferably, each of the plurality of content segments comprises content of a predetermined duration.

Preferably, the predetermined duration is selected from one or more of the following ranges: 0-10 seconds; 10-20 seconds; 20-30 seconds; 30-40 seconds; 40-50 seconds; 50-60 seconds.

Preferably, each of the plurality of content segments comprises content of a predetermined file size.

Preferably, each of the plurality of content segments comprises an item of content.

Preferably, each of the plurality of content segments has a marker.

Preferably, the marker comprises metadata, the metadata comprising one or more of the following: channel identifier; date; time; content segment identifier; item identifier; item type; item artist name; item title; item album name; item type; content segment duration; item duration.

Preferably, the template generator generates one or more templates in accordance with user preferences associated with a user device identifier received from the user device.

Preferably, the template comprises an order of play of time shifted, live broadcast content.

Preferably, the template comprises an order of play of on-demand content.

Preferably, the templates comprise a unique identifier associated with each content segment, and the one or more user devices request individual content segments based on the unique identifier.

Preferably, the templates comprise content categories selected from any one or more of: audio, music, advertisement, video, image, text.

Preferably, the order of play of the plurality of content segments is defined according to predetermined rules.

Preferably, the rules comprise computer code defining play out of a plurality of categories of content according to a configurable ratio such that a first category is given a greater play out bias than a second category.

Preferably, the rules are defined at least in part by one or more selected from: content generators; service providers and broadcasters.

Preferably, the system further comprises: a database storing a library of user profiles, each user profile applying to a corresponding user device.

Preferably, the user profiles comprise data selected from one or more of: a user identifier; age; sex; income; educational attainment; home ownership; employment status; location; and a similar personal information item.

Preferably, a template is configured at least in part according to user profile data.

Preferably, the marker data is selected from one or more of: XML data; HTML data; and pulse data.

Preferably, the system further comprises: a synchronisation manager operable to communicate with the one or more user devices to transmit content segments based on one or more templates.

Preferably, the system is configured to transmit the requested content segments to the user device content buffer in the background, such that, in use, future content segments can be transmitted whilst a current content segment is played, and wherein playback of subsequent content segments begins immediately from the content buffer.

Preferably, the system is configured to transmit the requested content segments to the user device content buffer in the background, when a measured connection quality between the user device and the remote computer system is above a predetermined threshold at any time.

Preferably, the system further comprises: a research module operable to receive user input data captured from the one or more user devices.

Preferably, the user input data are used to populate user profiles.

Preferably, user input data comprises user preference information selected from one or more of: likes, dislikes, whether a user has followed an advertising link, how often the user receives content, what types of content are being received, playback frequency.

Preferably, the system further comprises: an advertising module operable to transmit advertising information to the one or more user devices, wherein the advertising information is one or more of: a logo or other graphical device, promotional information, contact information.

Preferably, the computer system further comprises an external interface for connection to one or more third party computer systems such that data can be sent from the research module directly to third-party systems.

Preferably, the system further comprises: a compression unit and wherein content segments are compressed before distribution to one or more user devices.

Preferably, the system further comprises: a digital rights management unit and wherein digital rights management is applied to content segments before distribution to one or more mobile devices.

Preferably, the content generator is operable to configure content output according to predefined parameters representing attributes of individual user devices.

Preferably, the attributes are selected from one or more of: aspects of the device operating system, screen size, resolution or other properties which vary from model to model.

Preferably, each content segment is an individual item of content comprising a meaningful content experience and capable of being played out to a user independently of other content segments.

Preferably, the system further comprises: a communication module configured to enable the sending of a message by Push Access Protocol to a user device without affecting playback of content.

Preferably, the message comprises one or more of: advertising information, news, stock quotes, weather, traffic reports, and notification of events.

Preferably, the at least one user device is a mobile phone, smart phone, PDA or other similar electronic device.

According to an aspect of the invention, there is provided a user device comprising an application for presenting media content received from a remote computer system, the application comprising: a network interface enabling communication with the remote computer system; a template module operable to receive a template comprising an order of play of a plurality of content segments from the remote computer system; a synchronisation module operable to request and downloaded at least one of the plurality of content segments indicated in the template from the remote computer system; a content buffer operable to store the downloaded content segments; and a user interface operable to present the content segments stored in the content buffer.

Preferably, the device further comprises: a registration module configured to enable a user to register for a channel, and wherein the registration module requests a template corresponding to the channel selected by the user from the remote computer system.

Preferably, the registration module requests a template corresponding to the channel selected by the user and a user device identifier from the remote computer system.

Preferably, the user interface is further operable to capture user inputs and, whenever a connection with the remote computer system is available, upload said user inputs to the remote computer system.

Preferably, the user inputs are associated with the user device identifier at the remote computer system.

Preferably, the user inputs indicate the users preferences to the digital content. Preferably, each of the plurality of content segments has a marker.

Preferably, the marker comprises metadata, the metadata comprising one or more of the following: channel identifier; date; time; content segment identifier; item identifier; item type; item artist name; item title; item album name; item type; content segment duration; item duration.

Preferably, the network interface enables communication of a link to the template corresponding to the channel selected by the user and a user device identifier to one or more second user devices.

Preferably, the synchronisation module is further operable to select algorithmically a content segment from the plurality of content segments downloaded to the content buffer be presented at the user interface.

Preferably, the selection is based on one or more of: user profile, user current location, motion of the user device, local time of day at the user device.

Preferably, data requests is made via HTTP and data transmission is made via TCP.

Preferably, the device further comprises: a DRM decode unit comprising the necessary key or password to access the content for decoding DRM applied to incoming content segments.

Preferably, the user interface comprises a dynamic holder for advertising information, and wherein this information is transmitted during playback of content.

Preferably, the application is configured to automatically detect whether a suitable network connection is available.

Preferably, the application is loaded, at least in part, when the operating system of the user device is loaded.

Preferably, the user interface displays information during presentation of content selected from one or more of: album art of a currently playing song, channel name, artist/title, tour information, promotional information connected with a particular artist.

Preferably, user inputs and/or user behaviour is converted in to user rewards corresponding to certain promotions, rebates and/or discounts.

Preferably, the template further comprises a timing of play of the plurality of content segments.

Preferably, the template further comprises content of the plurality of content segments.

Preferably, the device further comprises: a connection quality measurement module operable to determine connection quality between the user device and the remote computer system, such that, in use, in response to a measured connection quality above a predetermined threshold at any time, the connection quality measurement module determines an amount content segments to be downloaded by the synchronisation module.

According to an aspect of the invention, there is provided a method of processing content and delivering said content from a broadcast computer system to one or more user devices, the method comprising: constructing content for output by dividing the content into a plurality of content segments; generating a template comprising an order of play of the plurality of content segments; and transmitting the template to one or more user devices, and upon receipt of a request for at least one of the plurality of content segments indicated in the template, transmitting the requested content segments to a content buffer of the one or more user devices.

Preferably, the method further comprises: generating one or more templates in accordance with user preferences associated with a user device identifier received from the user device.

Preferably, the method further comprises: storing a library of user profiles, each user profile applying to a corresponding user device.

Preferably, the method further comprises: communicating with the one or more user devices to transmit content segments based on one or more templates.

Preferably, the method further comprises: transmitting the requested content segments to the user device content buffer in the background, such that, in use, future content segments can be transmitted whilst a current content segment is played, and wherein playback of subsequent content segments begins immediately from the content buffer.

Preferably, the method further comprises: transmitting the requested content segments to the user device content buffer in the background, when a measured connection quality between the user device and the remote computer system is above a predetermined threshold at any time.

Preferably, the method further comprises: receiving user input data captured from the one or more user devices.

Preferably, the method further comprises: transmitting advertising information to the one or more user devices, wherein the advertising information is one or more of: a logo or other graphical device, promotional information, contact information.

According to an aspect of the invention, there is provided a user device comprising an application for presenting media content received from a remote computer system, the application comprising: a network interface enabling communication with the remote computer system; a synchronisation module operable to request and downloaded at least one of the plurality of content segments from the remote computer system; a content buffer operable to store the downloaded content segments; a user interface operable to present the content segments stored in the content buffer; and a connection quality measurement module operable to determine connection quality between the user device and the remote computer system, such that, in use, in response to a measured connection quality above a predetermined threshold at any time, the connection quality measurement module determines an amount of content segments to be downloaded by the synchronisation module.

Preferably, each of the plurality of content segments has marker data.

Preferably, the marker data comprises metadata, the metadata comprising one or more of the following: channel identifier; date; time; content segment identifier; item identifier; item type; item artist name; item title; item album name; item type; content segment duration; item duration.

According to an aspect of the invention, there is provided a computer system for music content broadcasting comprising: a content source interface configured to receive a content input stream; a marker source interface configured to receive marker data corresponding to natural breaks in the content input stream; a content generator operable to construct a content output flow comprising a plurality of content segments generated based on the marker data; and a communication interface operable to transmit content segments to a content buffer of one or more user devices.

Preferably, the content input stream and marker data sources are independent.

Preferably, the system further comprises a template generator operable to generate one or more templates corresponding to an order of play of individual content segments, and send the one or more templates to the one or more user devices.

Preferably, the content generator constructs an order of play which is in a different order from the order content is received at the content source interface.

Preferably, the template defines order of play of time shifted, live broadcast content. Preferably, the template defines order of play of on-demand content.

Preferably, the one or more templates comprise a unique identifier associated with each content segment, and the one or more user devices request individual content segments based on the unique identifier.

Preferably, the one or more templates comprise content categories selected from any one or more of: music, advertisement, video, image, text.

Preferably, the content flow output comprises an order of play defined according to predetermined rules.

Preferably, the rules comprise computer code defining play out of a plurality of categories of content according to a configurable ratio such that a first category is given a greater play out bias than a second category.

Preferably, the rules are defined at least in part by one or more selected from: content generators; service providers and broadcasters.

Preferably, the computer system further comprises a database storing a library of user profiles, each user profile applying to a corresponding user device.

Preferably, the user profiles comprise data selected from one or more of: a user identifier; age; sex; income; educational attainment; home ownership; employment status; location; and a similar personal information item.

Preferably, a template is configured at least in part according to user profile data.

Preferably, the content source interface is a music automation system interface.

Preferably, the marker source interface is a radio station feed interface.

Preferably, the marker data is selected from one or more of: XML data; HTML data; and pulse data.

Preferably, the system further comprises synchronisation manager operable to communicate with the one or more user devices to transmit content segments based on one or more templates. Preferably, the system is configured to transmit content segments to the user device content buffer in the background, such that, in use, future content can be transmitted whilst a current content segment is played, and wherein playback of subsequent content segments begins immediately from the content buffer.

Preferably, the system further comprises a research module operable to receive user input data captured from the one or more user devices.

Preferably, the user input data are used to populate user profiles.

Preferably, user input data comprises user preference information selected from or more of: likes, dislikes, whether a user has followed an advertising link, how often the user receives content, what types of content are being received, playback frequency.

Preferably, the system further comprises an advertising module operable to transmit advertising information to the one or more user devices, wherein the advertising information is one or more of: a logo or other graphical device, promotional information, contact information.

Preferably, the computer system further comprises an external interface for connection to one or more third party computer systems such that data can be sent from the research module directly to third-party systems.

Preferably, the system further comprises a compression unit and wherein content segments are compressed before distribution to one or more mobile devices.

Preferably, the system further comprises a digital rights management unit and wherein digital rights management is applied to content segments before distribution to one or more mobile devices.

Preferably, the content generator is operable to configure content output according to predefined parameters representing attributes of individual user devices.

Preferably, the attributes are selected from one or more of: aspects of the device operating system, screen size, resolution or other properties which vary from model to model.

Preferably, each segment is an individual item of content comprising a meaningful content experience and capable of being played out to a user independently of other content segments.

Preferably, first and second segments comprise content from a plurality of different categories.

Preferably, the system further comprises a communication module configured to enable the sending of a message by Push Access Protocol to a mobile device without affecting playback of content.

Preferably, the message comprises one or more of: advertising information, news, stock quotes, weather, traffic reports, and notification of events.

Preferably, the at least one user device is a mobile phone, smart phone, PDA or other similar electronic device.

According to one aspect of the invention there is provided a user device comprising an application for receiving and presenting digital content received from a remote computer system, the application comprising: a user interface for receiving user inputs and presenting segments of content out of a content buffer; a memory interface with an on-device memory forming the content buffer; a network interface enabling remote communication with the remote computer system; and at least one template defining content segments to be transmitted to the content buffer from the remote computer system.

Preferably, the device further comprises a registration module configured to enable a user to register for a channel, and wherein the registration module contacts the remote computer system in order to request the template corresponding to the channel selected by the user.

Preferably, the device further comprises a synchronisation module operable to request and downloaded content segments based on information in the template.

Preferably, data requests is made via HTTP and data transmission is made via TCP.

Preferably, the device further comprises a DRM decode unit comprising the necessary key or password to access the content for decoding DRM applied to incoming content segments.

Preferably, the user interface comprises a dynamic holder for advertising information, and wherein this information is transmitted during playback of content.

Preferably, the user interface captures user inputs and, whenever a connection with the remote computer system is available, uploads said user inputs to the remote computer system.

Preferably, the application is configured to automatically detect whether a suitable network connection is available.

Preferably, the application is loaded, at least in part, when the operating system of the user device is loaded.

Preferably, the user interface displays information during presentation of content selected from one or more of: album art of a currently playing song, channel name, artist/title, tour information, promotional information connected with a particular artist.

Preferably, user inputs and/or user behaviour is converted into to user rewards corresponding to certain promotions, rebates and/or discounts.

According to an aspect of the invention, there is provided a method of processing content and delivering said content from a broadcast computer system to one or more mobile devices, the method comprising: receiving a content input stream at a content source interface; receiving marker data at a marker source interface, wherein marker data corresponds to natural breaks in the content input stream; constructing a content output flow comprising a plurality of content segments generated based on the marker data; and transmitting content segments to a content buffer of one or more user devices via a communication interface.

Preferably, the method further comprises generating one or more templates corresponding to an order of play of individual content segments, and sending the one or more templates to the one or more user devices.

Preferably, the template defines order of play of live, time-shifted content.

Preferably, the template defines order of play of on-demand content.

Preferably, the one or more templates comprise a unique identifier per content segment, and the one or more user devices request individual content segments based on the unique identifier.

Preferably, the one or more templates are generated according to content categories selected from any one or more of: music, advertisement, video, image, text.

Preferably, the content flow output comprises an order of play defined according to predetermined rules.

Preferably, the rules comprise computer code defined to play out a plurality of categories of content defined according to a configurable ratio such that a first category is given a greater play out bias than a second category.

Preferably, the rules are defined at least in part by broadcasters and/or system administrators.

Preferably, the method further comprises storing in a database a library of user profiles, each user profile directed to a corresponding user device.

Preferably, the user profiles comprise data selected from one or more of: a user identifier, age, sex, income, educational attainment, home ownership, employment status, location or similar information.

Preferably, templates are configured on an individual user basis, according to rules defined at least in part according to user profile data.

Preferably, the content source interface is a music automation system interface and the marker source interface is a radio station feed interface.

Preferably, the marker data is any one of: XML data; HTML data; and pulse data.

Preferably, the method further comprises transmitting content segments to the one or more user devices based on synchronisation of one or more templates with the computer system.

Preferably, content segments are transmitted to the user device content buffer in the background whilst a current content segment is played, and wherein playback of subsequent content segments begins immediately from the content buffer.

Preferably, the method further comprising receiving user input data captured from the one or more user devices and using it to define, at least in part, templates.

Preferably, the user input data are used to populate user profiles.

Preferably, user input data comprises user preference information selected from or more of: likes, dislikes, whether a user has followed an advertising link, how often the user receives content, what types of content are being received, playback frequency.

Preferably, the method further comprises transmitting advertising information to the one or more user devices, wherein the advertising information is one or more of: a logo or other graphical device, promotional information, contact information.

Preferably, content segments are compressed by a compression unit before distribution to one or more mobile devices.

Preferably, digital rights management is applied by a digital rights management unit to content segments before distribution to one or more mobile devices.

Preferably, the method further comprises configuring content output according to predefined parameters representing attributes of individual user devices.

Preferably, the attributes are selected from one or more of: aspects of the device operating system, screen size, resolution or other properties which vary from model to model.

Preferably, each segment is an individual item of content comprising a meaningful content experience and capable of being played out to a user independently of other content segments.

Preferably, first and second segments comprise content from a plurality of different categories.

Preferably, the method further comprises sending of a message by Push Access Protocol via a communication module to a mobile device without affecting playback of content.

Preferably, the message comprises one or more of: advertising information, news, stock quotes, weather, traffic reports, and notification of events.

Preferably, the at least one user device is a mobile phone, smart phone, PDA or other similar electronic device.

According to one aspect of the invention, there is provided a computer system for broadcast of content to individual content consumers, the computer system comprising: a content feed interface configured to receive a stream of broadcast content; a marker data interface configured to receive marker data logically associated with the broadcast content and at least some of the marker data indicating natural breaks between individually consumable content items of the broadcast content stream; a content generator operable to process the broadcast content into segments based on said marker data and to generate a least one template defining order of play of a plurality of content segments; and a communication module operable to transmit content segments according to the template to a mobile device.

Preferably, the computer system further comprises a synchronisation module configured to transmit a plurality of content segments to a mobile device responsive to a synchronisation request from the mobile device.

Preferably, said synchronisation request from a mobile device identifies a template.

According to one aspect of the invention, there is provided a remote device capable of receiving and playing broadcast content to a user, comprising: a memory; a media player module arranged to play out a sequence of independently consumable content items according to an order of play defined in a template, the template comprising a plurality of content segments each having a unique identifier; a synchronisation module operable to request content from a remote content store according to the template and queue a predetermined amount of content segments in the memory for play out; and a network interface configured to allow communications with a remote content store.

According to one aspect of the invention, there is provided an article of manufacture comprising: a machine readable storage medium; and executable program instructions embodied in the machine readable storage medium that when executed by a programmable system cause the system to perform functions that process content and deliver said content from a broadcast computer system to one or more mobile devices, the functions comprising: receiving a content input stream at a content source interface; receiving marker data at a marker source interface, wherein marker data corresponds to natural breaks in the content input stream; constructing a content output flow comprising a plurality of content segments generated based on the marker data; and transmitting content segments to a content buffer of one or more user devices via a communication interface.

According to one aspect of the invention, there is provided an article of manufacture comprising: a machine readable storage medium; and executable program instructions embodied in the machine readable storage medium that when executed by a programmable system cause the system to processing content and delivering said content from a broadcast computer system to one or more user devices, the functions comprising: constructing content for output by dividing the content into a plurality of content segments; generating a template comprising an order of play of the plurality of content segments; and transmitting the template to one or more user devices, and upon receipt of a request for at least one of the plurality of content segments indicated in the template, transmitting the requested content segments to a content buffer of the one or more user devices.

According to one aspect of the invention, there is provided a computer program product comprising programme code means for performing the methods described above.

According to one aspect of the invention, there is provided a computer readable medium recorded with computer readable code arranged to cause a computer to perform the methods described above.

According to one aspect of the invention, there is provided a computer programme code means for performing the methods described above.

### BRIEF DESCRIPTION OF THE DRAWINGS

For a better understanding of the invention and as to how the same may be carried into effect reference will now be made, by way of example only, to the accompanying drawings, in which like reference numerals refer to corresponding parts throughout the figures, and in which:

FIG. 1A illustrates a radio broadcast system according to an embodiment of the present invention;

FIG. 1B illustrates a radio broadcast system according to an embodiment of the present invention;

FIG. 2 illustrates more detail of an embodiment of the broadcast server;

FIG. 3 shows an example of a stereo audio signal processed by content generator;

FIG. 4 shows an example of an output from content generator in which content segment output is customised according to a number of different mobile devices;

FIG. 5 shows an example of a “synthesized” template generated by template generator;

FIG. 6A illustrates an example of a order of play defined by a synthesized template;

FIG. 6B illustrates a process by which once a content segment has finished playback, it is placed at the bottom of the order of play;

FIG. 6C illustrates a process by which once the content segment has finished playback it may be placed randomly in the order of play;

FIG. 7A shows a schematic representation of a live albeit time shifted broadcast;

FIG. 7B shows a situation at the end of playing content segment;

FIG. 7C shows a schematic representation of the download of data to a buffer;

FIG. 7D shows a schematic representation of packet being played

FIG. 7E shows another schematic representation of the download of data to a buffer

FIG. 7F shows a schematic representation of signal strength variation in relation to time;

FIG. 8 illustrates more detail of the user application residing on a mobile handset;

FIG. 9 shows a typical process by which content is processed by the content generator and delivered to one or more mobile devices;

FIG. 10 illustrates how the template generator generates a synthesized template;

FIG. 11 illustrates a schematic representation of a user personalised playlist; and

FIG. 12 illustrates schematic representation of the download of data to a buffer.

### DETAILED DESCRIPTION

Reference will now be made in detail to the embodiments of the invention, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

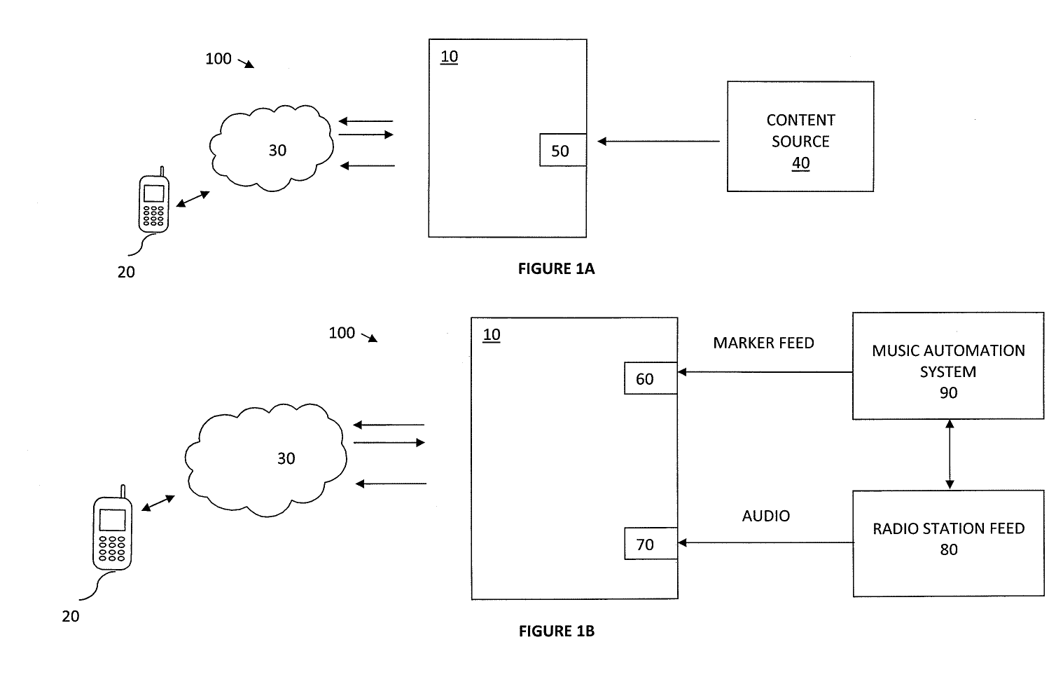

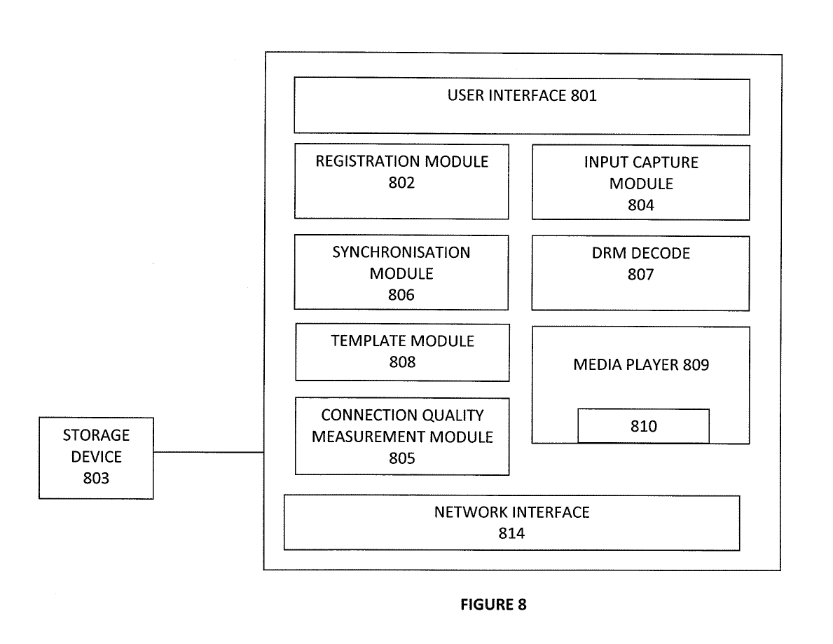

FIG. 1A illustrates a radio broadcast system according to an embodiment of the present invention 100. The system comprises a server 10 operable to transmit content to and receive data from one or more user devices 20 through a suitable network 30. The at least one user device 20 is typically a mobile (cellular) phone, smart phone, PDA or other similar electronic device equipped with a digital signal processor, a subscriber identity module (SIM) card, WLAN or some other network connection hardware, memory, and so forth. According to embodiments of the present invention, the mobile device 20 has a user application 800 (see FIG. 8). The server 10 is operably connected to at least one content source 40, through a suitable content source interface 50.

FIG. 1B illustrates a radio broadcast system according to an embodiment of the present invention, wherein the content source interface 50 of FIG. 1A is replaced by a music automation system interface 60 and a music feed interface 70. In this case, the music feed is a radio station feed 80. The radio station feed 80 constitutes a source of content, in this case radio audio content streamed from one or more radio stations. According to one embodiment, this audio content is streamed in WAV format. However, according to other embodiments, the audio content may be streamed in other formats, e.g. MP3, AAC, AIFF, PCM, FLAC, AC3. As will be evident to the skilled person, the radio station feed 80 is only one example of a content source, and other content sources may be used for broadcasting any type of media. For example, alternatively, or in addition, the content source could be a video feed from news broadcaster or a video feed from a television station.

The music automation system 90, in this embodiment a radio automation system, according to FIG. 1B, provides metadata relating to the radio station feed and which separates content (in this example, audio data) into distinct segments. Preferably, metadata is XML data. The radio station feed 80 and radio automation system 90 are logically linked, for example by suitable network connection 95, such that the metadata (XML markers) correspond to distinct segments of audio streaming from radio station feed 80. This is described in more detail below. In certain other embodiments, the metadata of the automation system feed is implemented using HTML markers or similar alternative markers. It is even possible to provide the automation system feed markers by means of a hardware card connection (e.g. a physical I/O card and associated logic) using voltage pulse marking or similar as the metadata markers.

The network 30 is typically a cellular network, however, it may be any other type suitable for wirelessly transmitting/receiving data, such as the Internet, an intranet, a wireless local area network (LAN) and/or a metropolitan area network (MAN). The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

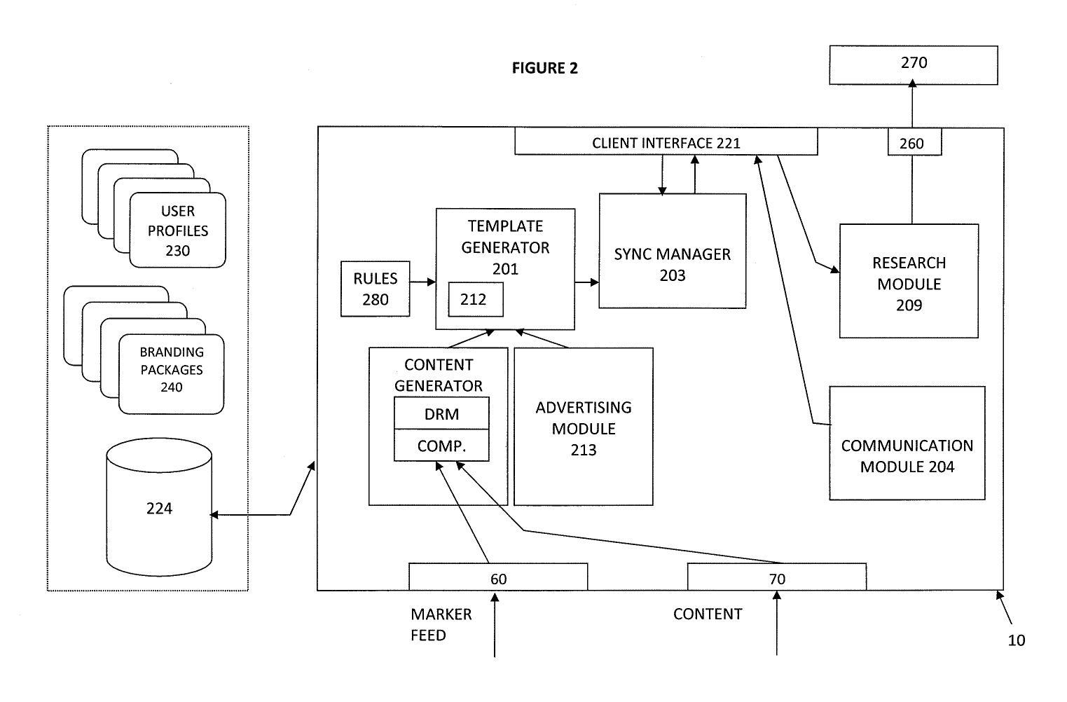

FIG. 2 illustrates more detail of an embodiment of the broadcast server 10. The broadcast server 10 comprises: a template (road map) generator 201, a synchronisation manager 203, a communication module 204, a research module in 209, a content generator 211, an advertising module 213, an interface 60 to the music automation system 90, a content interface 70 and a client interface 221. The broadcast server 10 also comprises a database 224 for storing a library of user profiles 230 and one or more branding packages 240, as well as templates and other items generated by the server 10. According to one embodiment, the database is controlled by a relational database management system such as MySQL.

The user profiles 230 comprise one or more of a user identifier, such as a name or a username, together with personal information, such as demographic information including: age, sex, income, educational attainment, home ownership, employment status, location. Optionally, the broadcast server 10 further comprises an external interface 260 for connection to one or more third party computer systems 270. This enables data to be sent from the research module 209 directly to third-party systems.

According to the embodiment illustrated in FIG. 2, content is streamed from a radio station feed. According to other embodiments, the feed can originate from any source and in any format, e.g. MPEG-4, QuickTime, Real Media, Adobe Flash. File delivery may be handled in a number of ways. For example, where the feed provides video files, file delivery can be handled either by transfer to the server 10 via normal TCP and include the files into one or more templates; or buffering the video via embedded HTML. For example, in case of a live QuickTime broadcast, a separate QuickTime streaming server may be used to provide the stream and embed HTML markers at the device.

According to another embodiment, content may be provided in a data store, e.g. in database 224, which has been uploaded by content providers and/or users of the system via a suitable network connection such as the Internet.

The content generator 211 is operable to receive content, record that content and then process and store it in a local data store. It is also operable to receive a metadata feed which is used to separate the content into distinct segments. The content generator uses the metadata feed (typically an XML feed or similar) to define content segments, which can then be compressed according to any compression scheme (for example AAC, MP3, MP4, FLAC etc.) and have digital rights management applied.

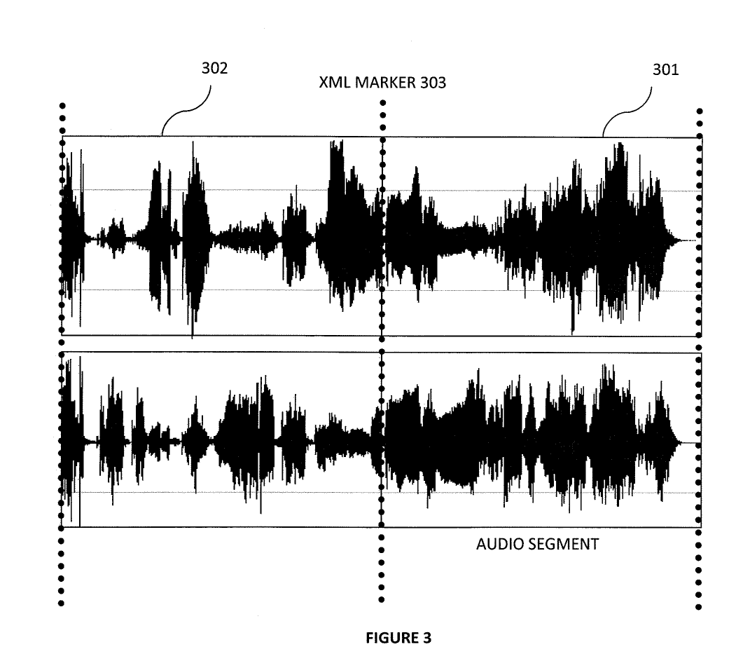

FIG. 3 shows an example of a stereo audio signal processed by content generator 211. The content generator 211 records the content feed. When the content generator 211 receives a marker, such as an XML marker 303, it creates a file for the segment of content preceding the marker 301 and begins a new file for the segment of content following the marker 302. Upon receipt of the next XML marker, the same procedure is carried out until a directory of content segments 301, 302, 303 . . . etc. is built up. Markers may be placed, for example, at natural breaks in the broadcast content, such as at the interfaces of songs and intervening speech. Alternatively, markers may be created at predetermined file sizes or duration of content. The same principles apply to any content type. For example, rather than audio segments, 301 and 302 could similarly represent segments of video or a segment of audio followed by a segment of video, or any other combination. The term “segments” in the context of the embodiments of the present invention refers to content separated by a natural break in a manner that such segment elements of the broadcast stream can be pieced together in a meaningful way.

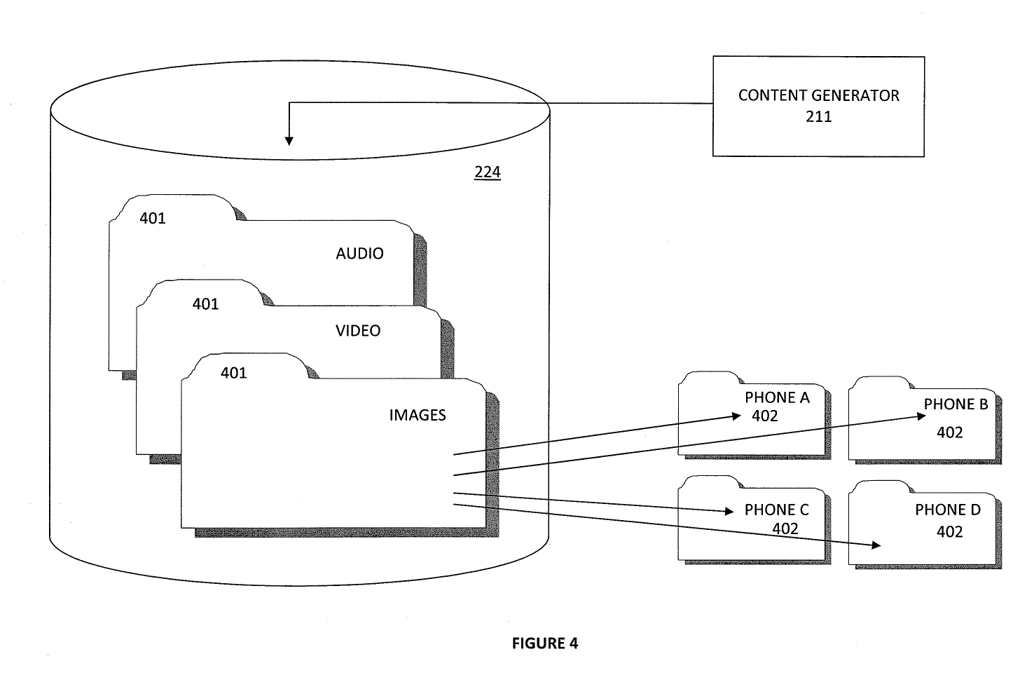

FIG. 4 shows an example of an output from content generator 211 in which content segment output is customised according to a number of different mobile devices. In the example shown, each content type has its own folder 401, e.g. for audio, text, video, images etc. Each folder 401 has two or more subfolders 402, generally representing different mobile device types. For instance, the folder labelled “Phone A” may comprise one or more content portions specifically configured for displaying on a particular phone model, taking into account for example aspects of the device operating system or screen size, resolution or other properties which vary from model to model. Similarly, the folder labelled “Phone B”may comprise the same one or more content portions as in the “Phone A” folder, but those images configured for displaying on a different phone model. Thus, generally, the content generator 211 is operable to configure its output of content according to predefined parameters representing attributes of mobile devices 20 and create separate file directories for storing the customised content segments.

Referring again to FIG. 2, the template generator 201 is operable to generate, and where appropriate, manage, “templates”. In the context of the present embodiment, the term “template” is used to describe an order of play (or playlist) of one or more segments of content. In most cases the output of the template generator 201 can be thought of as a “synthesized template” 1001, which is constructed according to rules which define selection of content segments from any one or more predefined templates. In other words, for example, the template generator 201 generates an order of play by selecting different items from a number of different playlists. The rules 280 are defined and stored separately from the templates and are defined, at least in part, by the broadcaster and/or, at least in part, according to user preferences stored in user profiles 230. As will become apparent from the description hereinafter, the synthesized template for output to an individual user device may be a replication of another template recorded in the system or it may be constructed from content sourced from a plurality of other templates recorded in the system. Further, embodiments of the invention may comprise any reasonable number of live and/or on demand templates or even a plurality of live and/or on demand templates.

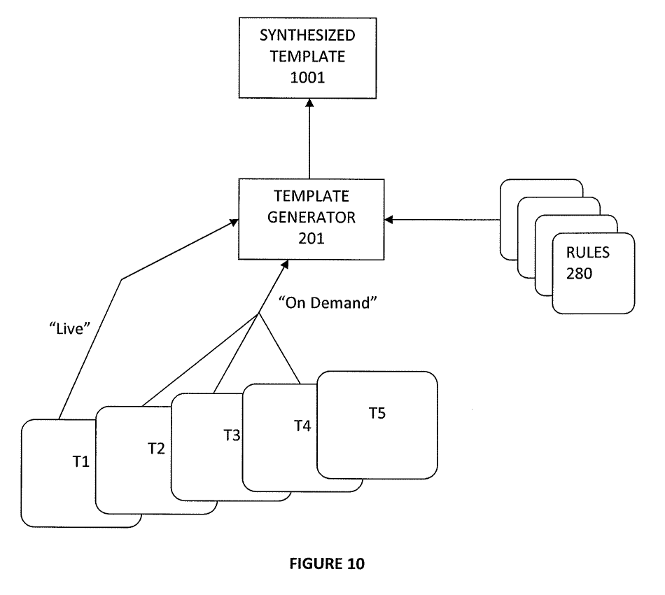

FIG. 10 illustrates how the template generator 201 generates a synthesized template 1001 according to an embodiment of the present invention. In general the synthesized template controls the order of play of the segmented content on the mobile device. Where the broadcast is live, for instance, the rules in this case simply instruct the template generator 201 to output the content segments in the order they appear from the live feed. In other words, the synthesized template for the live broadcast is simply the content segments in the same sequential order as supplied by the live feed. According to one embodiment, a live broadcast may utilise more than one template.

The terms “live service” and “live broadcast” are used herein to refer generally to a live synthesized template playing out content coming from the content source feed in the order in which it arrives from the content source feed. However, live broadcasts are generally time shifted in the sense that content segments are played out of the buffer on the user device, rather than “streamed” directly from the source.

Alternatively, by extracting content from different templates, e.g. any one or more of T1-T5, according to different predefined rules 280 in order to create the synthesized on-demand template for output, it is possible to provide a dynamic, “on-demand service” as an output. Thus, the on-demand output can be constructed so as to have specifically selected segmented content and controlled order of play of the segmented content by means of the template mechanism.

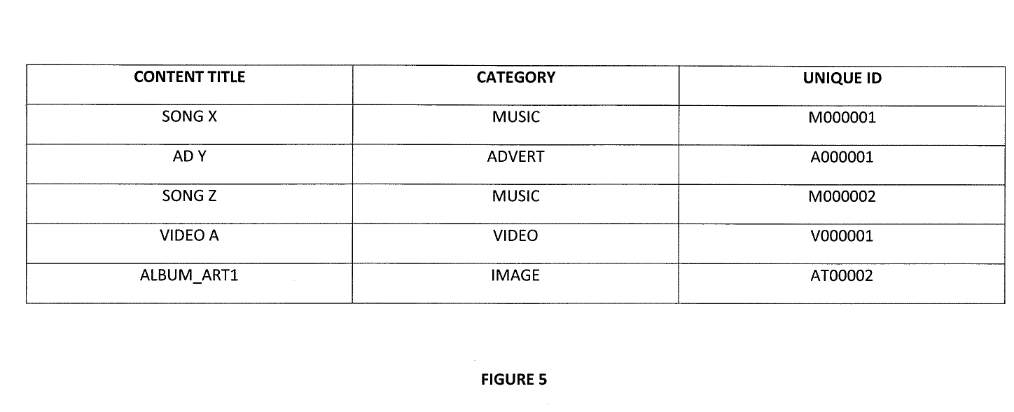

FIG. 5 shows an example of a “synthesized” template generated by template generator 201. According to embodiments of the present invention, a template may be generated for any type of content service. A channel, for example one provided by a service such as radio station or television station, may wish to have a number of different templates targeted at different users based on, for instance, user profiles and/or predefined broadcast rules. It may also be desirable to have templates which play different content at different times of day. For example, rules may be defined such that the synthesized template is configured to play a high proportion of dance hits during the day but, during the evening, the template is replaced or reconfigured to play a higher proportion of, for instance, easy listening music. A “channel” may comprise a “live (albeit time-shifted) service”, an “on-demand service” or both. Each of these will be described in more detail below.

In the example shown in FIG. 5, the template is defined according to title, category and unique ID. The category may be any selected from music, advertisement, video, image, text or any other. The unique ID is a unique identifier for each segment of content. According to other embodiments, templates may include other, additional fields. According to one embodiment, a template may be defined according only to category and unique ID. The order in which the entry's unique IDs appears within the synthesized template defines the order of play, with each unique ID representing one segment of content. According to one embodiment, there are defined rules for selecting certain templates or categories of content from certain templates in order to construct the synthesized template for output. In one embodiment rules define how content may be selected randomly but with a configurable bias. For example, a template rule may define that synthesized “Template X” should play out 50% new music, 30% old music and 20% advertisement. In addition, or in the alternative, a rule may also define that these biases change after a certain time. For instance, after 10 p.m., “Template X” should play out 60% old music, 20% new music and 20% advertisement. Order of play may be determined by a control function pulling content from a plurality of templates according to a set of rules (see 280 as described above) and placing them in the synthesized template in the order in which they are to be played out. According to one embodiment, user profile data can at least in part define and control synthesized templates. For example: the user's age may be used to define rules that play a greater proportion of newer music than older music; user preference data may be used to customise templates in terms of genre and/or artist, e.g. avoiding a certain genre that the user has indicated a disliking for.

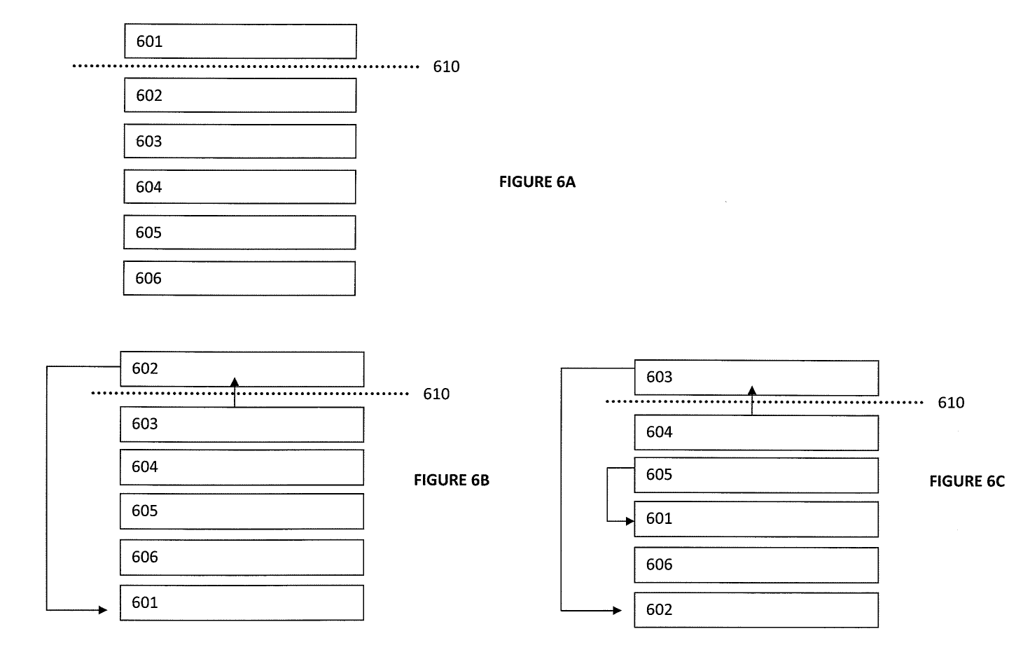

Templates are requested from server 10 by synchronisation module 806 of the mobile device and transmitted to mobile device 20 by synchronisation manager 203. Templates are used by user application 800 to request content from the server 10, and to play that content in the order defined in the template. According to one embodiment, however, order of play is randomised by a percentage amount by the user application 800 after receipt of the template (see FIG. 6C). In one embodiment, identical synthesized templates are sent to all users requesting a service. In certain embodiments, corresponding synthesized templates are sent to a plurality of users so that the content experience and order of play is the same for that subset of users. In another embodiment, different users or different categories of users may have different synthesized templates determined by for example their selection of channel and or service. Alternatively, or in addition, different users or different categories of users may have different synthesized templates determined for example based on a rule configured by an administrator and/or a rule or applying specifically to the user as a consequence of a attribute in the relevant user profile. According to one embodiment, a plurality of templates are sent to the user device and the user application 800 generates a synthesized template, preferably utilizing rules in a manner analogous to that described above.

FIG. 6A illustrates an example of a order of play defined by a synthesized template. In the example shown in FIG. 6A, the template defines the order in which segments 601, 602, 603 . . . etc are played by user application 800 (see FIG. 8) in “on demand” mode. In one embodiment each of the segments represents an individual item of content as shown in FIG. 4. The segment 601 at the top of the order of play 610 represents the content item currently being played through the user application 800. The segments 602, 603, 604 etc., represent content items that will be played subsequently, i.e. content segments stored in the buffer. The content segments that will be played subsequently (602, 603, 604 etc) are downloaded to the memory of the mobile device 20 in the background, whilst the current segment (601) is being played. This process is done by communication between synchronisation module 806 on the mobile device 20 and synchronisation manager 203 on server 10. Thus, when playback of the current segment finishes, or the user elects to skip the segment, subsequent segments are already stored locally on the mobile device such that playback of them can begin immediately and it is not necessary for the user to wait for download to complete. According to one embodiment, the buffer on the mobile device is configured to hold 8 segments at a time, corresponding to a playback time of approximately 40 minutes.

The manner in which content playback is ordered within a template may be done according to preference, either the broadcaster's, the individual user's, the system administrator's or a combination of two or more. For instance, following the example shown in FIG. 6, segment 601 may represent a single audio track, segment 602 may represent an audio advertisement, segment 603 may represent another audio track, segment 604 may represent a video etc. According to one embodiment, each segment is an individual item of content. For example, segment 601 may represent an audio file (a single song or part of a radio broadcast), segment 602 may represent an audio advert (or alternatively a video advert) etc. However, according to another embodiment, each segment may comprise a plurality of different content items. For example, the segment 601 as shown in FIG. 6 may be an audio file with an embedded image, such as album artwork, and/or an advertisement displayed a text. In other words, a single segment may actually be a conglomeration of audio data, video data, text data or any other content.

According to one embodiment, once the content segment has finished playback, it is placed at the bottom of the order of play. This arrangement is shown in FIG. 6B. According to one embodiment, once the content segment has finished playback it may be placed randomly in the order of play. Randomness in this context means either completely random or random with a certain bias towards different content categories, genres, artists etc. This arrangement is shown in FIG. 6C. According to one embodiment, the order of play may be constantly shuffled after playback of each content segment, such that playback of content segments from the buffer of the mobile device is further adjusted or randomised by the user application.

The template generator 201 has a user interface 212 which enables content/service providers to define and manage templates. Most typically, user interface 212 is a web-based user interface, operable to accept input from a user at a desktop computer through a web browser, and transmit those inputs via the network 30 to the template generator 201. The user interface 212 may be implemented in, for example, Java, AJAX, Adobe Flex, Microsoft .NET, or similar technologies.

The content provider may also wish to incorporate advertising into their content broadcast. To this effect, template generator 201 is in operable communication with advertising module 213. The advertising module 213 is configured to handle all branding and packaging aspects of content delivery according to embodiments of the present invention. According to one embodiment, the user application 800 comprises a dynamic holder for advertising information, for example, a logo or other graphical device, promotional information, contact information and such like, and this information is transmitted over the network 30 to user application 800 running on a mobile handset 20 during playback of content. What information and how this type of information is displayed can be defined within the template. According to one embodiment, the advertising information, for example, logos or other graphical devices, promotional information, slogans, Internet URLs, contact information and such like is stored within branding packages 240. Each content provider may have one or more branding packages 240.

Referring again to FIG. 2, the synchronisation manager 203 is configured to communicate with user application 800, residing on mobile device 20, in order to ascertain whether the correct and/or most up-to-date data is stored on the mobile device. This reconciliation process is used for both the on demand broadcast and live broadcast to ensure that data is actively synchronised between the content provider and end user.

The synchronisation manager 203 manages aspects of “live broadcasts”. In this application, live broadcasts are analogous to internet radio with at least some time shift capability, in the sense that the user has control over what programmes (channels) listen to and when. Content is divided into segments, as described above, and those segments are sent by server 10 to a user's mobile device.

It is a feature of preferred embodiments of the present invention that content segments are buffered in the local memory such that content is always played from the memory of the mobile device, not played directly from a streamed data feed. The system and methods of the disclosed embodiment are therefore advantageous over not only terrestrial radio, where the user has no control over programming, track selection or scheduling, and digital radio, where the user may have some control of scheduling through ability to pause, rewind and record live radio, but also over streamed radio because content is always played from the memory of the mobile device and therefore does not require continuous active data connection. Hence, the disclosed apparatus and methods are advantageous over the prior art in that users can freely play content, such as radio, in situations when the mobile device has no network connection, for instance, on underground trains, in tunnels or other places where there is limited or zero signal. The user can also skip and select content as well as determine aspects of the scheduling.

The amount of content in the buffer (local memory) of the mobile device is managed by the user application and can be any predetermined amount, specified in terms of data size or in terms of a fixed amount of time. According to one embodiment, the synchronisation manager 203 on server 10 communicates with synchronisation module 806 to ensure that the buffer is always full. The amount of buffered content is typically sufficient to establish consistent and reliable playing out, as well as to deliver the skip and content selection benefits of preferred embodiments. According to one embodiment, the buffer is between 1 and 120 minutes in length in terms of playback time. Preferably, it is between 30 and 50 minutes in length and most typically it about 40 minutes of content is stored in the buffer.

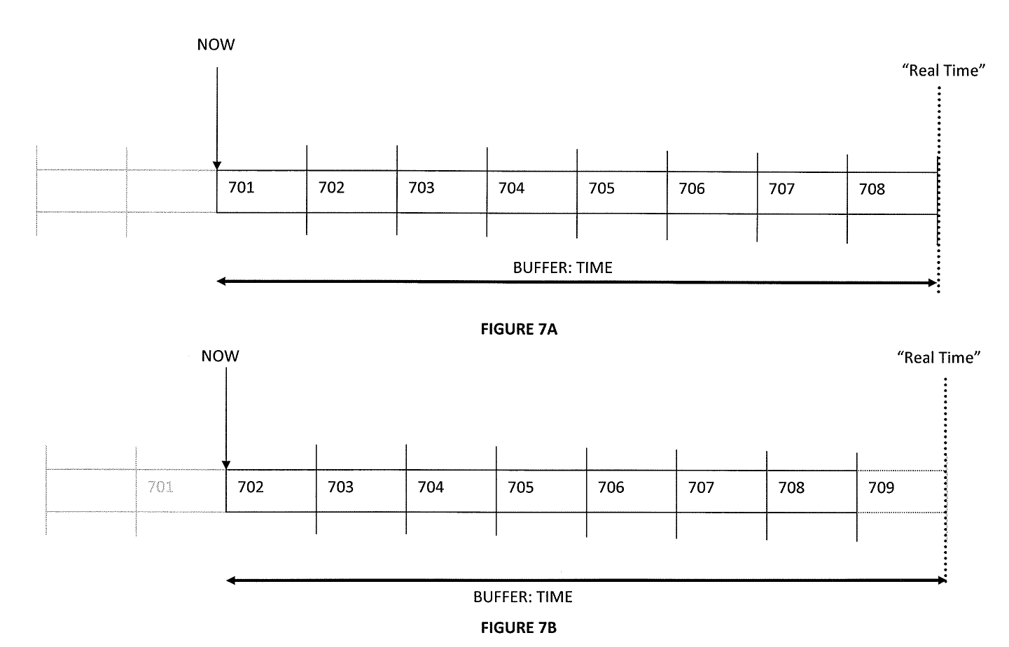

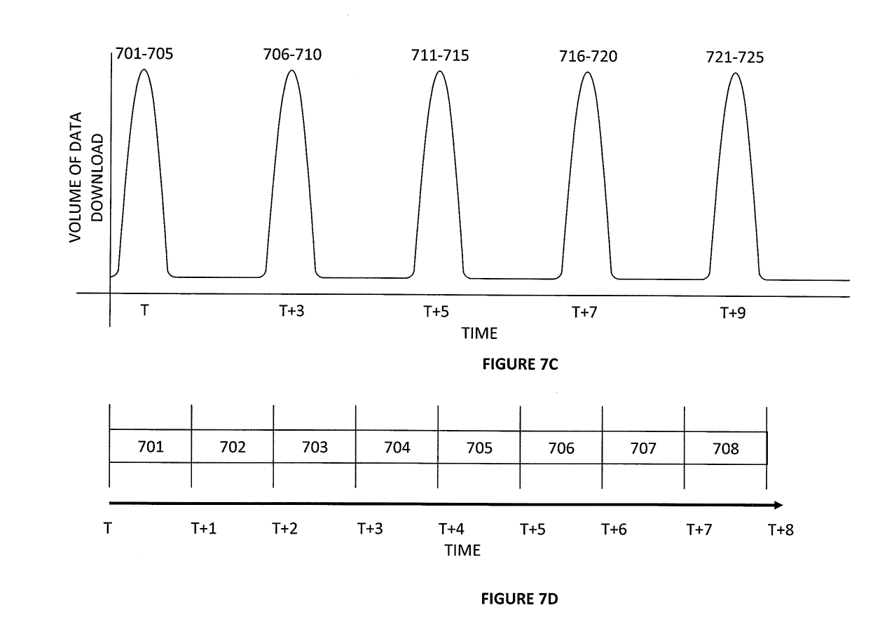

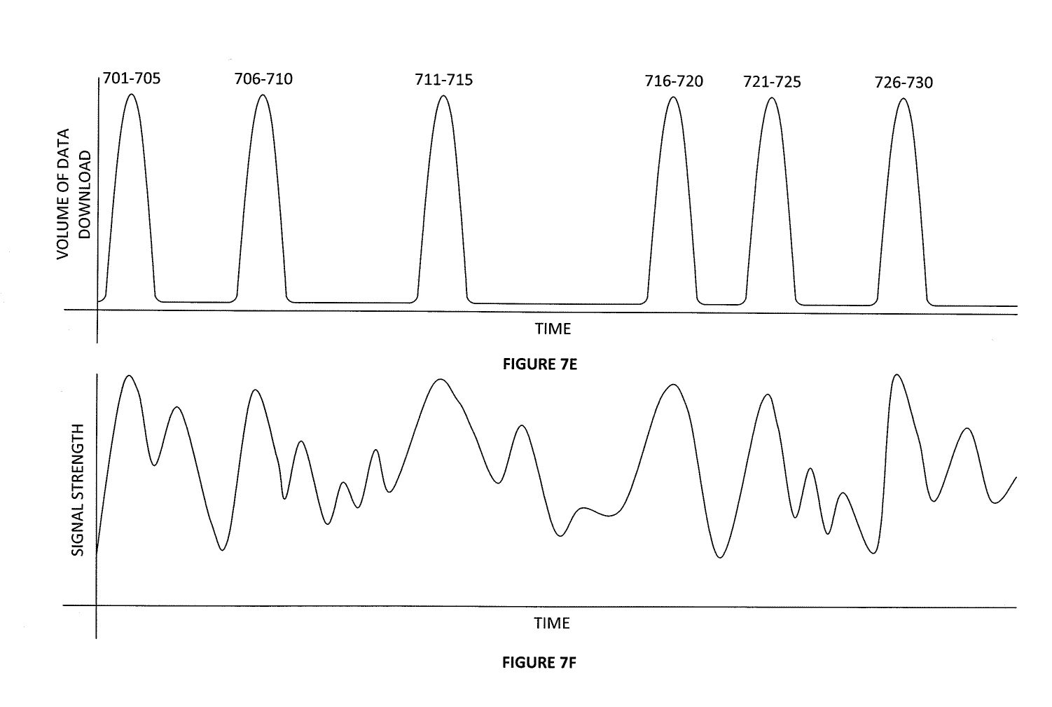

FIG. 7A shows a schematic representation of a live albeit time shifted broadcast. The arrow labelled “NOW” represents the content segment currently being played by the user application 800, i.e. in this example segment 701. The segments 702-708 represent content segments which have been buffered in the local memory of the mobile device 20. The buffer size is T=40 minutes in length, however, the buffer size is not limited to a particular size. The line labelled “real time” represents the end of the most up-to-date content segment. A user is able to skip between any content segments currently in the buffer. However, since content is played from the memory of the mobile device 20, a user is only able to go forward as far as the beginning of the segment before the line marked “real time” (i.e. the beginning of segment 708 in this example), since this represents the most up-to-date content segment available. If the user does skip as far as a threshold, in this case the segment preceding the “real-time” marker, the synchronisation manager 203 will automatically begin to transfer the next segment (i.e. segment 709 in FIG. 7B) to the local memory of the mobile device. Hence, when segment 708 has finished playing, segment 709 is immediately available for playback by accessing it from the local memory of the mobile device.

According to one embodiment, users are permitted to skip certain segments of content but re not permitted to skip other segments of content. For instance, a user may be permitted to skip audio tracks but not permitted to skip adverts. According to one embodiment, there is a countdown timer which displays when the skipping of content items is not permitted. This timer may display information to the user, e.g. “back to the music in X seconds”, where X corresponds to the amount of time until the next content item which can be skipped.

FIG. 7B shows a situation at the end of playing content segment 701. Once the buffer is no longer full, the synchronisation module 706 will send a request to the synchronisation manager 203 for the next segment(s) of content, and delete the content segment just played (represented in the figure by greyed out segment 701). Typically this request is done by Hypertext transfer protocol (HTTP). The user application 800 then begins to play the next segment of content. This is illustrated in FIG. 7B by the “NOW” marker moving to the right. At the same time, the synchronisation manager 203 will transmit the latest segment of content (e.g. segment 709) in order to fill up the buffer. This transmission is typically done by transmission control protocol (TCP).

According to another embodiment, when storing content segments to the memory (i.e. buffer) of the user device, each segment becomes part of an internal scheduling system. In other words, once each song has been downloaded to memory, it becomes part of a ‘rotation clock’ which makes sure that, even if the mobile device has no available network, the user application 800 plays content items on rotation, such that the application does not play the same sequence of songs back to back, and hence the user has the illusion of a changing source. According to one embodiment, user application 800 is operable to generate one or more synthesized templates from a number of different locally stored templates in this regard. For example, the user application may play 3 songs from template A, 6 songs from template B, 12 songs from template C etc. According to another embodiment, user application 800 simply randomises content playback. According to one aspect, while the user listens to this type of on-demand channel, the input capture module 804 saves user behaviour (e.g. buttons pressed) and once a connection is available again, this data is uploaded to the research module 209.

As stated above, markers may be created at predetermined file sizes or duration of content. In one embodiment, content is separated into segments such that each segment is a predetermined duration of content. For example, the segments 701 to 708 illustrated in FIG. 7D may each comprise content lasting 10 seconds, 20 seconds, 1 minute, 2 minutes etc. The segments do not represent specific items, instead the broadcast content is divided up into segments, such that a specific item may be represented by several segments. Some of the segments may be required to be played in order, for example segments 702 and 703 together contain an item of content such as a song and therefore are required to be played in order. However, other segments may not be required to be played in order.

Each segment is divided by a XML marker. Below is an example of a XML marker indicating the types of data defined in the marker.

<?xml version=“1.0” encoding=“UTF-8”?>
<MMIPlay>
<content>PLAYLIST</content>
<datas>
<items channel_id=“386” lib=“HitMusic” date=“22/05/2009”>
<item uid=“701”>
<hour>08:01:43</hour>
<id=“137392” type=“JINGLE”/>

<title>-Station ID1</title>

<artist>ID</artist>
<audioURL></audioURL>
<albumart></albumart>
<lyricsURL></lyricsURL>

<microSiteURL></micrositeURL>

<ontourURL></ontourURL>
<duration>14854</duration>
<posstart>774</posstart>
<poschain>13786</poschain>
</item>
<item uid=“702”>
<hour>08:04:43</hour>
<id=“137393” type=“SONG”/>

<title>-Celebration</title>

<artist>MADONNA</artist>
<audioURL></audioURL>
<albumart></albumart>
<lyricsURL></lyricsURL>

<microSiteURL></micrositeURL>

<ontourURL></ontourURL>
<duration>14854</duration>
<posstart>774</posstart>
<poschain>13786</poschain>
</item>
</items>
</datas>
</MMIPlay>

The types of data defined in the marker may be a channel identifier (i.e. an identifier of the radio or TV station); date; time; content segment identifier; item identifier (an identifier for each segment—thus if an item has been divided into several segment, each segment will have the same item identifier, but different segment identifiers); item type (i.e. audio, video, etc); item artist name; item title; item album name; content segment duration; item duration.

FIGS. 7A and 7B describes downloading a stream of segments such that the buffer is continuously begin replenished as content is retrieve from the buffer. FIG. 7C illustrates schematically, another method of downloading content to the buffer. In FIG. 7C packets of content (a plurality of segments) is download from the server to the buffer at the user device, at predetermined intervals. As can be seen in FIG. 7C a packet containing segments 701-705 is downloaded at time T, then no data is download for a period of time, followed by a packet containing segments 706-710 being downloaded at time T+3, then no data being download for a period of time, followed by a packet containing segments 711-715 being downloaded at time T+5 etc.

This intermittent downloading of packets does not effect the play back of the content. FIG. 7D illustrates schematically play back of the content of each segments at the user device. As can be seen segment 701 is played at time T, segment 702 is played at time T+1, segment 703 is played at time T+2 etc. As stated above, with reference to FIG. 7C, a packet containing segments 706-710 is downloaded at time T+3, so by the time segment 706 is required for play back at time T+5, the segment has already been downloaded to the buffer, such that the segments are provided in the buffer at the users device before they are required for playing.

FIG. 7E illustrates schematically, another method of downloading content to the buffer. In FIG. 7C packets of content (a plurality of segments) are download from the server to the buffer at the user device, at predetermined intervals. However, in contrast to the arrangement of FIG. 7C, the packets are not downloaded at predetermined intervals in FIG. 7E, instead the packets are downloaded whenever the signal strength of the user device is high (above a predetermined level). FIG. 7F illustrates schematically variations in the signal strength of the user device over time. As can be seen when comparing FIGS. 7E and 7F, whenever the signal strength of the user device is high, a packet of segments is downloaded. This arrangement increases the efficiency of the device since it is not trying to download data when there is poor signal strength. The user application uses a connection quality measurement module 805 (illustrated in FIG. 8) to determine transmission conditions, such as connection speed/ping time/signal strength between the user device and the remote computer system. In one embodiment the uses an API call to measure the connection speed/ping time/signal strength.

The user application may also monitor how much data is stored in the buffer. For example, if the signal strength is low for a long period of time, then the device may attempt to download packets even though the signal strength is low, in order to avoid the buffer becoming empty.

As with the embodiments of FIG. 7A a request for packets is done by Hypertext transfer protocol (HTTP).

Referring again to FIG. 2, the communication module 204 is configured to enable the sending of information by Push Access Protocol, also known as “push text”, to a mobile device 20 without affecting playback of audio, video, etc. According to one embodiment, this feature is used to display advertising information as content is being played through user application 800. It may also be used to display other information such as news, stock quotes, weather, traffic reports, and notification of events.

The research module 209 gathers user data from the input capture module 804, which is part of the user application 800. This is most typically user preference information, for example, whether a user likes or dislikes a certain song, whether a user has followed an advertising link, how often the user uses the application, what types of content are being streamed/downloaded, play frequencies etc.

FIG. 8 illustrates more detail of the user application 800 residing on mobile handset 20. The user application 800 as access to a local memory/storage device 803 (a portion of which is also referred to herein as a “buffer”). The memory 803 is typically the internal memory of the mobile handset 20, however, it may alternatively be an external memory device such as Flash memory card, or any other suitable memory.

The user application 800 comprises: a user interface 801, a registration module 802, a input capture module 804, and on device synchronisation module 806, a DRM decode unit 807, a template module 808, a media player 809 with access to a library of audio/video codecs 810 and a network interface 814. The audio/video codecs 812 enable the media player 809 to support any number of content format types. According to one embodiment, the user application 800 uses the media player included with the mobile device software, rather than being a stand-alone application.

When the mobile device user loads the application 800, the user interface 801 is displayed and the registration module 802 is initiated. In the first instance, this allows a user to register for a service, i.e. to request a broadcast from a certain channel. According to one embodiment, for a given channel, the user is presented with an option of either an on demand service or a live service. Next, the registration module typically displays registration information, such as terms and conditions of usages, usage instructions, etc., and at the same time instructs the on device synchronisation module 806 to contact the server 10 in order to request the template corresponding to the channel selected by the user. This request is typically done via HTTP. The synchronisation manager 203 then receives the request and sends the correct template back to the user application 800, typically via TCP. The template may be stored in template module 808.

Once the synthesized template has been received by the user application 800, the on device synchronisation module 806 will contact the synchronisation manager 203 to determine what content to download into the buffer. Templates comprise a plurality of content identifiers (IDs) ordered to define an order of play. Once the template synthesized by the template generator has been received by the user application 800, the synchronisation module 806 sends the content IDs from the template to the synchronisation manager 203 in the form of a request. According to one embodiment, this request is done via HTTP. The synchronisation manager 203 then sends back the content segments corresponding to the requested content IDs to the user application. According to one embodiment, this sending is done via TCP. The media player 809 is also able to use the template to determine how content, i.e. audio files, adverts, videos and other content, once downloaded should be recalled from the memory 803 and presented to the user of the mobile handset 20.

According to one embodiment of the present invention, content delivery always occurs in the background, in other words such that the user is unaware that content is being downloaded, for example during content playback without interrupting playback.

During playback of content, or when playback is paused but the application is still loaded, the synchronisation module 806 contacts the synchronisation manager 203 (when network connectivity is available) to download content segments in accordance with upcoming items in the template. In this regard, the application 800 determines upcoming content items (in the form of content segments) and downloads and stores these content items in the memory 803 of the mobile handset, where they can be accessed by media player 809 when required. If no network connectivity is available, this is done as soon as connectivity is re-established.

Similarly, during playback of content, or when playback is paused but the application is still loaded, the synchronisation module 806 is operable to upload data received by the input capture module 804 and/or content stored in memory 803 back to research module 209 via network 30 (when network connectivity is available). If no network connectivity is available, this is done as soon as connectivity is re-established. Typically, this data includes user preference information, browsing habits and other user data collected and stored offline.

If the user selects the live service, the synchronisation module 806 requests from the server 10 the live synthetic template corresponding to the chosen channel and content segments are played sequentially.

If the user selects the on demand service, the synchronisation module 806 communicates with the synchronisation manager 203 residing on the broadcast server 10 in order to ascertain whether the content on the mobile handset 20 is fully up-to-date with the latest information on the server 10. According to one embodiment, this request is made as a HTTP request. If it is determined by the synchronisation module 806 that content is not up to date, it sends a request to receive the most up to date synthesized template(s) for the service selected, in order to determine the necessary content segments required for playback. According to one embodiment, the data is sent to the mobile device 20 by the server 10 via TCP.

The optional DRM decode unit comprises the necessary key or password to access (playback) the content packaged by content generator 211. Operationally, it is accessed by the media player 809 before playing content and content will only be downloaded if the DRM of the content segment matches that in the DRM decode unit. This unit is only required if optional DRM is applied to the content at the server end.

The user application 800 supports a plurality of different mobile device types from different manufacturers. According to one example, user application 800 is Java-based. However, other programming languages may be used as appropriate. According to one embodiment, the user application 800 is preloaded onto the mobile device as part of its manufacturing process. According to another embodiment, the application 800 can be downloaded onto the mobile device by a user, for instance, via the Internet or a suitable data cable connected to a desktop computer.

In use, application 800 can be started by a user, for example, by selecting it from an applications menu or otherwise. Once the application is loaded, user is able to select a channel and/or install new channel.

If a suitable network connection, e.g. WiFi, 3G or Edge, is available, after selecting a channel the user application 800 immediately starts playing content and ‘buffering’ (downloading) additional content in the background and queuing it up ready for playback. This is referred to as the user application 800 being in ‘online playback’ mode. Optionally, selection of a channel prompts selection between live or on-demand content.

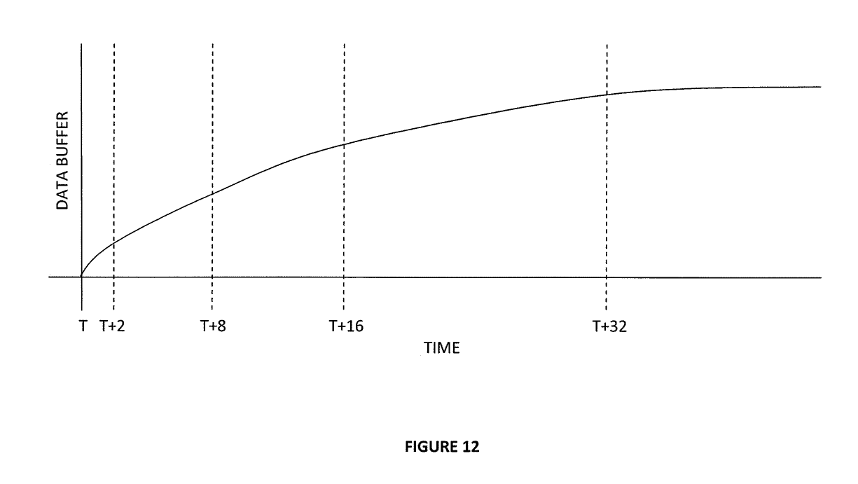

FIG. 12 illustrates schematically the time required to initiate online playback once the user application 800 has been started. In embodiments of the prior art, initiation of playback is not commenced until a predetermined amount of content has been transferred to the buffer. For example, the buffer may require a 1 minute buffer, it may take 15 seconds for the relevant amount of content to be transferred to the buffer. Therefore, playback does not commence for 15 seconds. This is considered very frustrating for users.

In contrast, the user application 800 may comprise a staggered buffer which is used upon initiation. The buffer may also require a 1 minute buffer as in the prior art, however, upon initiation of the user application 800 playback may commence when the buffer only has 4 seconds of content in the buffer, such that playback commence after 2 seconds.

As illustrated in FIG. 12, initially at (T+2), the amount of content in the buffer is very small. However, the amount of content in the buffer is then increased, such that at T+8 there are 16 seconds of content in the buffer, at T+16 there are 32 seconds of content in the buffer, and at T+32 there are 64 seconds of content in the buffer etc., and then this 1 minute buffer is maintained for the duration that the user is using the user application connection. By staggering the amount of content required in the buffer upon initiation, the user does not need to wait as long to begin using their device.

The user application 800 is configured to automatically detect whether a suitable network connection is available. If a suitable network connection is not available, the user application 800 will configure itself for ‘offline playback’, in other words, playback of locally stored content without real-time data connection to any suitable network.

The offline playback mode according to embodiments of the present invention is advantageous over the prior art for several reasons. One example is that it is possible to serve the listener even when there is no connection available, for example, when the user is commuting on a train where there is poor signal coverage. It also enables, for instance, a user to playback content when they are abroad, without having to connect to the network in order to download content.

On the other hand, in one embodiment, when the application 800 is in online playback mode it is configured to check expired links and songs and starts downloading in the background only if it is determined that content is needed.

According to one embodiment, the user application 800 is loaded, at least in part, when the operating system of the mobile handset is loaded. To this effect, the user application 800 will be quicker to launch. According to one embodiment, this enables the user application 800 to do downloading/uploading operations in the background without the user having to load the application.

According to one embodiment, the user application 800 is configured to display various types of information during playback of content. For example, the application may be configured to display the album art of a currently playing song, as well as channel name, artist/title information, and so on. Other types of information may also be displayed, for example, tour or promotional information connected with a particular artist.

According to one embodiment, the user application 800 is controlled by inputs, and most typically one or more soft key inputs. The inputs may include standard (QWERTY) and/or non-standard configurations of symbols on the displayed icons on the screen of the mobile device. According to one embodiment, user application 800 has inputs enabling the user to rate the currently playing segment of content.

According to one embodiment, the user application 800 is configured to generate a log of relevant actions done on the user device 20. According to one embodiment, the data contained in this log is recorded anonymously. According to one embodiment, the data in the log is associated with a user account and used in order to gather and stored user preference information.

According to one embodiment, the user application uses the device date/time to control timed events. For instance, the template generator 201 and/or synchronisation manager 203 can assign a one or more timed events which occur (a) at a certain date and time, or (b) recurring on a cycle of a predetermined number of minutes or (c) when one or more predefined items of content have played. The same can also be used to change various functions, for instance, one or more of a: change to a certain template; send a push text and show in display for X minutes; insert content item C; insert content of category Z etc. According to another example, this feature is used to force a timed event to interrupt current content item playback, e.g. the News starts at top of the hour.

According to one embodiment, there is an automatic update facility of the user application 800 to ensure that the user application is updated to the latest version in the background.

The input capture module 804 gathers user input data from user interface 801 and sends this data back to research module 209, which turns all the values into research data that can be used to control and create content for the channel, or be passed to a third party for use in creating, for instance, track popularity statistics.

In addition, the input capture module 804 keeps track of user behaviour and turns it into data which can be used for commercial purposes. For example, every minute of content listened to by the user may equate to 1 point. When points reaches a predetermined amount, the user may be eligible for certain promotions, rebates, discounts etc. According to one embodiment, the research module 209 sends user details to a third party 270 automatically.

According to one embodiment, the mobile handset has a built-in automation system with a graphical user interface (GUI), one or more processors, memory and one or more modules, programs or sets of instructions stored in the memory for performing multiple functions. In some embodiments, the user interacts with the GUI primarily through five button interface. In some embodiments, the functions may include XML commands, instant messaging, digital photographing, digital videoing, web browsing, digital music playing, and/or digital video playing. Instructions for performing these functions may be included in a computer readable storage medium or other computer program product configured for execution by one or more processors.

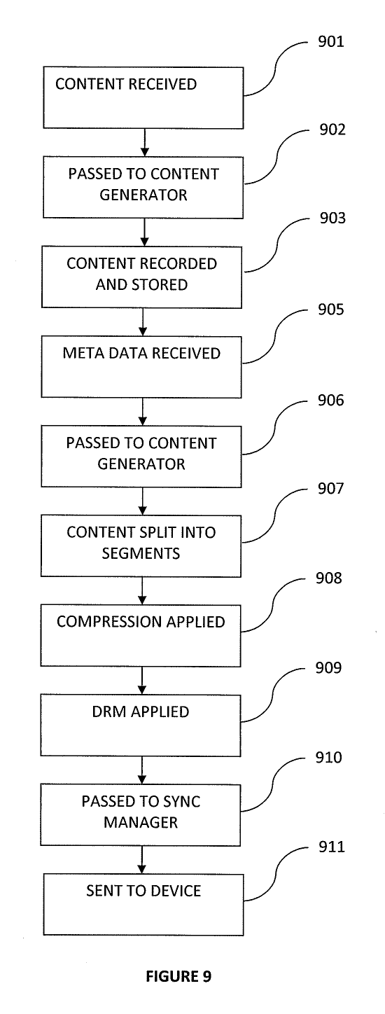

FIG. 9 shows a typical process by which content is processed by the content generator 211 and delivered to one or more mobile devices 20. Content is received 901 at content interface 219 and passed 902 to content generator 211. The content generator 211 begins to record (copy data) any content received 903 at content interface 70 and stores it in a local data store, for example database 224. At the same time, a metadata feed is received 905 at feed interface 60, and is likewise passed 906 to content generator 211. The content generator 211 uses the metadata to divide content 907 into separate segments. Exemplary methods by which this is done according to embodiments of the present invention were described in accordance with FIGS. 4 and 5 above.

Optionally, once the audio (or other content) has been split into segments, the content generator 211 applies 908 a suitable compression to the uncompressed audio. According to one embodiment, the content generator 211 applies Advanced Audio Coding (AAC), a standard type of compression and encoding scheme, to incoming WAV audio data packets received at content interface 219. However, other compression schemes may be used as required. Accordingly, according to one embodiment, the content generator 211 has access to a library of encoding schemes. According to one embodiment, the content generator 211 applies 909 suitable Digital Rights Management (DRM) in order to control user access to the content and prevent unauthorised distribution and copying. Content segments are then passed 910 to the synchronisation manager 203, which then controls how the content is distributed 210 based on requests from the user application as described in accordance with FIG. 8. Content is sent 911 to the device via client interface 221.

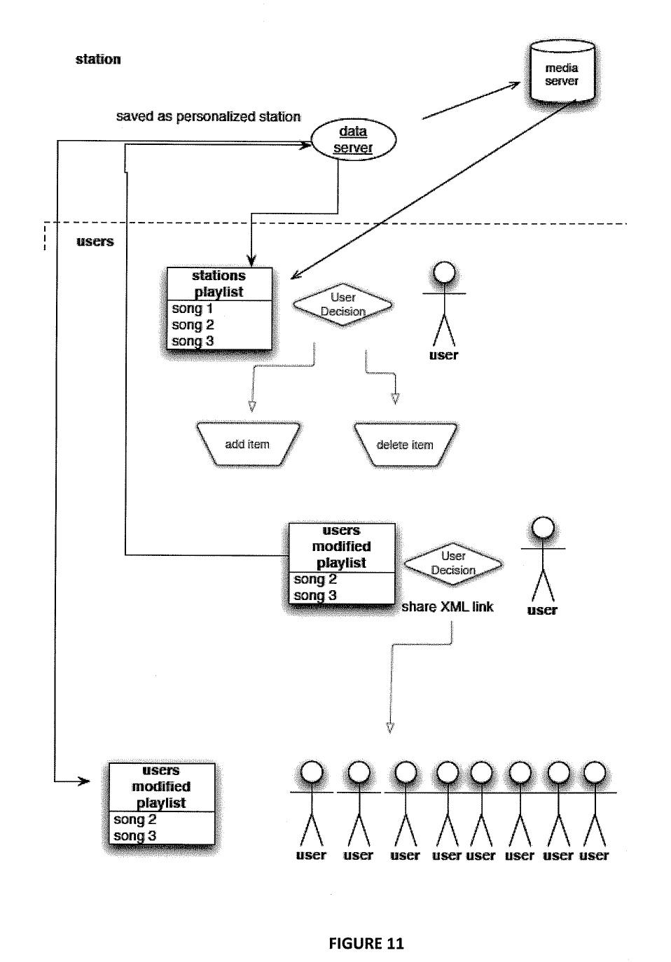

FIG. 11 illustrates a process for enabling a user to create a personalised playlists during either online or offline playback. As illustrated data (media) content is streamed from a data server 10 to a user device. The data may be a playlist from the radio station, which may include a plurality of items such as songs/DJ comments/advertisements etc. In order to create a personalised playlist, as each item within the (in one example, radio station) playlist is played at the user device, the user can select whether to “add” or “delete” the item.

If the user selects to “delete” the item, then the item is stopped playing on the users device and the playlist moves to the next item. In addition, it is noted that the user has selected to “delete” the item, and the item is marked with a low preference, such that it will not appear in the users personalised playlist.

If the user selects to “add” the item, then the item is continued to be played, it is noted that the user has selected to “add” the item (i.e. the user likes the item), and the item is marked with a high preference, such that it will appear more often in the users personalised playlist.

If the user does not select to “add” or “delete” the item, then the item is continued to be played, but it is not marked (no preference is attributed to the item). The item may or may not appear again on the user personalised playlist.

The users personalised playlist can be considered as a (in one example, radio station) playlist combined with the users preferences. For example, if the radios station playlist includes an item that the users has selected to “delete” then this item(s) will not appear in the users personalised playlist, if the radio station playlist includes an item that the users has selected to “add” then this item(s) will appear more often in the users personalised playlist. Items which the users has neither selected to “delete” or “add” may or may not appear in the personalised playlist, depending on whether they appears in radio station playlist (e.g. if an item appear in the radio station playlist, then it appears in the personalised playlist, whereas if an item does not appear in the radio station playlist, then it does not appear in the personalised playlist).

The users personalised playlist can be saved by the user and distributed to the users friends. The actual playlist of item is not saved, rather an XML link of the users playlist, linking back to the items saved at the data sever/media server 10 is shared with the users friends. The users friends can then listen to the user playlist by accessing the link. The user playlist, with associate preferences is constantly being updated with items from the data server in accordance with the users preferences. In order to listen to the user playlist, the friend activates the link to the user playlist and receive the items from the data server, the actual items are not copied to the friends device.

When the users personalised playlist is sent to their friends, the friend(s) can accesses the users personalised playlist (using the link), such that when the friend is listening to the radio stations, any items that the users has selected to “delete” will not be played at the friends device even when it is played by the radio station, and any items that the users has selected to “add” will have a higher preference, and thus will be played more often at the friends device.

The friend(s) can also create personalised playlist by selecting to “delete” or “add” items as they are played such that friend also creates a friends personalised playlist.

Although a user may have selected to “delete” an item, as is known in the art, radio station many play a particular item several times a day/week/month. If the popularity of an item increases (determined by radio play/sales/requests etc), it may appear again on a playlist at the users device such that the user can confirm their selection to “delete” or “add” the item. In another embodiment, each selection may have an associated duration (for example 1 week, 1 month etc) for which the selection is applied. After expiration of the duration the item may revert back to a non-selected item which can then be selected again by the user.

FIG. 8 illustrates the user application 800. The user application 800 comprises an interface 801 through which the user may select a radio station for playing and select to “delete” or “add” an item. The input capture module 804 capture the user selections for creating a personalised playlist. The user selections (preferences) may be transferred to template generator 201. In addition, the user selections (preferences) may be transferred to the research module 209 at the server 10 such that, for example, the popularity of an item may be determined.

When the user selects a radio station, the users radio station selection together with the user device identifier (UDID) of their device is sent to the server 10. If it is the first time that the user has selected the radios station, then there will not be any preferences associated with the radio station and the UDID of their device stored at the template generator 201. Consequently the standard radio station template is transferred to the template module 808 at the user application. However, if there are preference associated with the radio station and the UDID of their device, the template generator creates a personalised user template incorporating the standard radios station template and the user preferences, and transfers the personalised user template to the template module 808 at the user application.

The standard radio station template/personalised user template is used to create the playlist in combination with the items which are transferred to the buffer 803. The template is transferred before the items are transferred to the buffer.

In another embodiment, the synchronization module 806 at the user device can select algorithmically from one of a plurality of content segments available at the content buffer 803 to be played at a given time slot. This selection may be based on the user profile, the current location of the user device, motion of the user device, local time of day at the user device, or other media-external factors available to the user device at the time the segments are being downloaded.

Therefore, the user application is capable of reflecting the user's lifestyle and can adopt on-going changes e.g. if the user is at the gym or if it starts to rain at the users location, the user application is able to select content segments (songs) which are appropriate. For the example of the user being at the gym, the user application may only select songs which have a high beats per minute.

Those skilled in the art will appreciate that while this disclosure describes what is considered to be the best mode and, where appropriate, other modes of performing the invention, the invention should not be limited to the specific configurations and methods disclosed in this description of the preferred embodiment.

1. A computer system for media content broadcasting comprising:
a content generator operable to construct content for output by dividing the content into a plurality of content segments;
a template generator for generating a template comprising an order of play of the plurality of content segments; and
a communication interface operable to transmit the template to one or more user devices, and upon receipt of a request for at least one of the plurality of content segments indicated in the template, transmitting the requested content segments to a content buffer of the one or more user devices.

2. The system according to claim 1 wherein each of the plurality of content segments comprises content of a predetermined duration.

3. The system according to claim 2 wherein the predetermined duration is selected from one or more of the following ranges: 0-10 seconds; 10-20 seconds; 20-30 seconds; 30-40 seconds; 40-50 seconds; 50-60 seconds.

4. The system according to claim 1 wherein each of the plurality of content segments has a marker data.

5. The system according to claim 4 wherein the marker data comprises metadata, the metadata comprising one or more of the following: channel identifier; date; time; content segment identifier; item identifier; item type; item artist name; item title; item album name; item type; content segment duration; item duration.

6. The system according to claim 4 or 5 wherein the marker data is selected from one or more of: XML data; HTML data; and pulse data.

7. The system according to claim 1 wherein the template generator generates one or more templates in accordance with user preferences associated with a user device identifier received from the user device.

8. A user device comprising an application for presenting media content received from a remote computer system, the application comprising:
a network interface enabling communication with the remote computer system;
a template module operable to receive a template comprising an order of play of a plurality of content segments from the remote computer system;
a synchronisation module operable to request and downloaded at least one of the plurality of content segments indicated in the template from the remote computer system;
a content buffer operable to store the downloaded content segments; and
a user interface operable to present the content segments stored in the content buffer.

9. The device according to claim 8 further comprising:
a registration module configured to enable a user to register for a channel, and wherein the registration module requests a template corresponding to the channel selected by the user and a user device identifier from the remote computer system.

10. The device according to claim 9 wherein the user interface is further operable to capture user inputs and, whenever a connection with the remote computer system is available, upload said user inputs to the remote computer system.

11. The device according to claim 10 wherein the user inputs are associated with the user device identifier at the remote computer system.

12. The device according to claim 11 wherein the user inputs indicate the users preferences to the digital content.

13. The device according to claim 8 wherein each of the plurality of content segments has marker data.

14. The device according to claim 13 wherein the marker data comprises metadata, the metadata comprising one or more of the following: channel identifier; date; time; content segment identifier; item identifier; item type; item artist name; item title; item album name; item type; content segment duration; item duration.

15. The device according to any of claims 9 to 14 wherein the network interface enables communication of a link to the template corresponding to the channel selected by the user and the user device identifier to one or more second user devices.
